(19) United States
(12) Patent Application Publication
(10) Pub. No.: US 2018/0178514 A1
(43) Pub. Date: Jun. 28, 2018

(54) LIQUID JET HEAD AND LIQUID JET RECORDING DEVICE

(71) Applicant: SII Printek Inc., Chiba-shi (JP)

(72) Inventor: Daiki IROKAWA, Chiba-shi (JP)

(21) Appl. No.: 15/855,115

(22) Filed: Dec. 27, 2017

(30) Foreign Application Priority Data
Dec. 28, 2016 (JP) 2016-255171

(51) Int. Cl. B41J 2/14

(52) U.S. Cl. CPC B41J 2/1433

(57) ABSTRACT

There are provided a liquid jet head and a liquid jet recording device each capable of further reducing the accumulation of the foreign matters or the bubbles in the periphery of the jet hole to thereby stably jet the liquid from the jet hole. The liquid jet head is provided with a pressure variation chamber, a return channel, a circulation channel, and a jet hole. The pressure variation chamber applies a pressure variation to a liquid filled therein. The return channel is communicated with an outflow part of the pressure variation chamber on an upstream side thereof, and extends in a direction crossing an outflow direction of the liquid from the outflow part. The circulation channel is communicated with a downstream side of the return channel, and extends in a direction crossing the return channel, so as to return the liquid to an upstream side of the pressure variation chamber. The jet hole jets the liquid outside, the liquid flowing out from the pressure variation chamber. The jet hole is disposed in an area of the return channel except an upstream side connection area connected to the outflow part of the pressure variation chamber and a downstream side connection area connected to the circulation channel.

### RELATED APPLICATIONS

This application claims priority under 35 U.S.C. § 119 to Japanese Patent Application No. 2016-255171 filed on Dec. 28, 2016, the entire content of which is hereby incorporated by reference.

### BACKGROUND OF THE INVENTION

### Field of the Invention

The present invention relates to a liquid jet head and a liquid jet recording device.

### Background Art

There exists an inkjet printer equipped with an inkjet head as a device for ejecting ink (liquid) in a droplet state to a recording target medium (e.g., recording paper) to thereby record information (e.g., images and characters) on the recording target medium.

The inkjet head used here is normally provided with a fluid-pressure variation chamber for applying a pressure variation to the ink fed by a pump, and a jet hole for jetting the ink to the outside in response to the pressure wave generated in the fluid-pressure variation chamber.

Further, the jet hole is disposed on an axis line of an ink outflow part of the fluid-pressure variation chamber (see, e.g., Japanese Patent No. 5,047,958).

However, in the inkjet head described above, since the jet hole is disposed on the axis line of the outlet part of the fluid-pressure variation chamber, there is concern that foreign matters or bubbles mixed in the ink are accumulated around the jet hole, and the foreign matters or the bubbles thus accumulated may hinder smooth jet of the ink.

As the inkjet head for dealing with the problem, there are developed those of a circulation type, in which the ink not jetted from the jet hole is returned to the fluid-pressure variation chamber side through a return channel and a circulation channel.

In the inkjet head of the circulation type, the return channel communicated with the outflow part of the fluid-pressure variation chamber is connected substantially perpendicular to the outflow part, and the circulation channel is connected on the downstream side of the return channel substantially perpendicular to the return channel. In the case of the inkjet head of the circulation type, since the circulation flow of the ink occurs on the downstream side of the outflow part of the fluid-pressure variation chamber, it becomes hard for the foreign matters or the bubbles to be accumulated around the jet hole.

Currently, even in the inkjet head of such a circulation type, it is desired to study out a structure capable of further reducing the accumulation of the foreign matters or the bubbles in the periphery of the jet hole to thereby stably jet the ink from the jet hole.

Therefore, the invention has an object of providing a liquid jet head and a liquid jet recording device each capable of further reducing the accumulation of the foreign matters or the bubbles in the periphery of the jet hole to thereby stably jet the liquid from the jet hole.

### SUMMARY OF THE INVENTION

In order to solve the problems described above, in a liquid jet head according to an aspect of the invention, there are included a pressure variation chamber adapted to apply a pressure variation to a liquid filled in the pressure variation chamber, a return channel communicated with an outflow part of the pressure variation chamber on an upstream side of the return channel, and extending in a direction crossing an outflow direction of the liquid from the outflow part, a circulation channel communicated with a downstream side of the return channel, and extending in a direction crossing the return channel, so as to return the liquid to an upstream side of the pressure variation chamber, and a jet hole adapted to jet the liquid outside, the liquid having flown out from the pressure variation chamber, wherein the jet hole is disposed in an area of the return channel except an upstream side connection area connected to the outflow part of the pressure variation chamber and a downstream side connection area connected to the circulation channel.

According to this configuration, in the area except the upstream side connection area and the downstream side connection area on the return channel, since the liquid flowing back flows smoothly, the foreign matters or the bubbles become hard to be accumulated around the jet hole disposed in this part. Therefore, in the case of adopting this configuration, the obstruction of the jet of the liquid from the jet hole by the foreign matters or the bubbles accumulated is reduced, and the liquid becomes to be stably jetted from the jet hole.

It is also possible to arrange that the jet hole is disposed in a central area of the return channel between the upstream side connection area and the downstream side connection area.

In this case, since the jet hole is disposed in the area where the flow of the liquid flowing back becomes smoother, it becomes harder for the foreign matters or the bubbles to be accumulated around the jet hole.

Further, it is desirable to set the unit variation time (corresponding to the pulse width in the case of driving with the voltage pulse) in the pressure variation chamber so that the flow rate (referred to as an “ejection speed”) of the liquid in the jet hole becomes the maximum. In the case in which the flow channel area of the return channel is substantially equal in the extending direction, the unit variation time (referred to as “peak unit variation time”) in the pressure variation chamber maximizing the ejection speed becomes the maximum in the case in which the jet hole is located at the central position in the return channel. Further, if the position of the jet hole is shifted in the forward direction or the backward direction from the central position, the peak unit variation time gradually decreases in accordance with the increase of the displacement from the central position. Therefore, in the case in which the jet hole is disposed in the central area (the central area between the upstream side connection area and the downstream side connection area) of the return channel, and it is arranged that the pressure variation chamber is varied with the peak unit variation time corresponding to the arrangement position, even if the position of the jet hole is slightly displaced from the design position due to the manufacturing error or the like, the width between the upper limit error and the lower limit error of the ejection speed due to the displacement can be narrowed. Therefore, in the case of adopting this configuration, it is possible to reduce the variation in ejection speed between the products.

It is desirable for the jet hole to be disposed in an area of the return channel where a flow channel pressure loss from the upstream side connection area to the jet hole and a flow channel pressure loss from the downstream side connection area to the jet hole are substantially equal to each other.

In this case, since the jet hole is disposed in the area where the flow of the liquid flowing back becomes smoother, it becomes harder for the foreign matters or the bubbles to be accumulated around the jet hole.

Further, it is desirable for the unit variation time in the pressure variation chamber to be set so that the ejection speed in the jet hole becomes the maximum. The peak unit variation time maximizing the ejection speed differs by the position on the circulation channel, and is maximized in the case in which the jet hole is located at the position (referred to as a “pressure loss intermediate position”) where the flow channel pressure loss from the upstream side connection area and the flow channel pressure loss from the downstream side connection area on the return channel are equal to each other. Further, if the jet hole is displaced in the forward direction or the backward direction from the pressure loss intermediate position, the peak unit variation time gradually decreases in accordance with the increase of the displacement from the pressure loss intermediate position. Therefore, in the case in which the jet hole is disposed in the vicinity (the area where the flow channel pressure loss from the upstream side connection area to the jet hole and the flow channel pressure loss from the downstream side connection area to the jet hole are substantially equal to each other) of the pressure loss intermediate position on the return channel, and it is arranged that the pressure variation chamber is varied with the peak unit variation time corresponding to the arrangement position, even if the position of the jet hole is slightly displaced from the design position due to the manufacturing error or the like, the width between the upper limit error and the lower limit error of the ejection speed due to the displacement can be narrowed. Therefore, in the case of adopting this configuration, it is possible to reduce the variation in ejection speed between the products.

It is also possible that a jet hole plate having the jet hole is further included, and the return channel extends in a direction substantially perpendicular to an inflow direction of the liquid from the pressure variation chamber to the return channel, and an outflow direction from the return channel to the circulation channel, and extends in parallel to the jet hole plate.

In this case, since the return channel extends in a direction substantially perpendicular to the inflow direction of the liquid from the pressure variation chamber and the outflow direction to the circulation channel, it becomes easy for the foreign matters or the bubbles to be accumulated in the upstream side connection area and the downstream side connection area on the return channel. However, in the liquid jet head according to this aspect of the invention, since the jet hole is disposed in the area except the upstream side connection area and the downstream side connection area on the return channel, it is possible to particularly effectively prevent the foreign matters or the bubbles accumulated from hindering the jet of the liquid.

A liquid jet recording device according to another aspect of the invention is provided with the liquid jet head according to any one of the aspects of the invention described above.

According to the liquid jet recording device of this aspect of the invention, since the liquid jet head according to any one of the aspects described above is provided, it is possible to jet the liquid to the recording target medium with high quality.

According to this aspect of the invention, it is possible to further reduce the accumulation of the foreign matters or the bubbles in the periphery of the jet hole to thereby stably jet the liquid from the jet hole.

### BRIEF DESCRIPTION OF THE DRAWINGS

FIG. 1 is a schematic configuration diagram of a liquid jet recording device (an inkjet printer) according to an embodiment.

FIG. 2 is a schematic perspective view of a liquid jet head (an inkjet head) according to the embodiment.

FIG. 3 is a cross-sectional view along the III-III line in FIG. 2 of the liquid jet head (the inkjet head) according to the embodiment.

FIG. 4 is a partial cross-sectional perspective view of a head chip of the liquid jet head (the inkjet head) according to the embodiment.

FIG. 5 is a diagram schematically showing an experiment for examining the relationship between the position of the jet hole and the peak pulse width.

FIG. 6 is a graph showing the relationship between the position of the jet hole and the peak pulse width.

FIG. 7 is a graph showing the relationship between the pulse width of a voltage pulse and the ejection speed in the case of disposing the jet hole at a central position of a return channel, and in the case of disposing the jet hole at a position distant from the central position.

FIG. 8 is a schematic view for explaining the relationship between the interference of the pressure wave in the return channel and the position of the jet hole.

FIG. 9 is a schematic view for explaining the relationship between the interference of the pressure wave in the return channel and the position of the jet hole.

### DETAILED DESCRIPTION OF THE INVENTION

An embodiment according to the invention will hereinafter be described with reference to the accompanying drawings. In the following embodiment, the description will be presented citing an inkjet printer 1 (hereinafter simply referred to as a printer), which is a liquid jet recording device for performing recording on a recording target medium using ink (liquid), as an example. It should be noted that the scale size of each member is accordingly altered so that the member is shown large enough to recognize in the drawings used in the following description.

### [Printer]

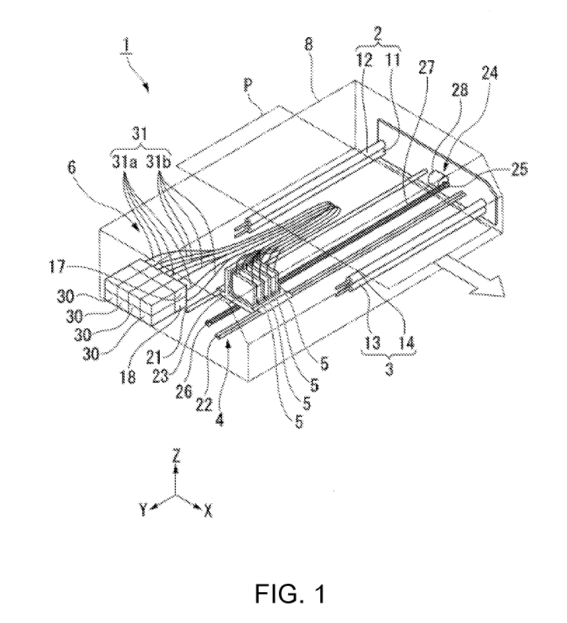

FIG. 1 is a schematic configuration diagram of the printer 1 according to the embodiment.

As shown in FIG. 1, the printer 1 of the present embodiment is provided with a pair of conveying mechanisms 2, 3, ink tanks 30, inkjet heads 5, an ink circulation unit 6, a scanning mechanism 4, wherein the pair of conveying mechanisms 2, 3 convey the recording target medium P such as paper, the ink tanks 30 each contain the ink, the inkjet heads 5 are each a liquid jet head for jetting the ink to the recording target medium P, the ink circulation unit 6 circulates the ink between the ink tanks 30 and the inkjet heads 5, and the scanning mechanism 4 performs a scanning operation with the inkjet heads 5, and these constituents are installed in a housing 8.

It should be noted that in the following explanation, the description is presented using a Cartesian coordinate system of X, Y, and Z as needed. In this case, the X direction coincides with the conveying direction of the recording target medium P (e.g., paper). The Y direction coincides with the scanning direction of the scanning mechanism 4. The Z direction is a direction perpendicular to the X direction and the Y direction. In the following explanation, the description will be presented defining the arrow direction as the positive (+) direction, and a direction opposite to the arrow direction as the negative (−) direction in the drawings out of the X direction, Y direction, and the Z direction.

The conveying mechanisms 2, 3 convey the recording target medium P in the X direction. Specifically, the conveying mechanism 2 is provided with a grit roller 11 extending in the Y direction, a pinch roller 12 extending in parallel to the grit roller 11, and a drive mechanism (not shown) such as a motor for making axial rotation of the grit roller 11. The conveying mechanism 3 is provided with a grit roller 13 extending in the Y direction, a pinch roller 14 extending in parallel to the grit roller 13, and a drive mechanism (not shown) for making axial rotation of the grit roller 13.

The scanning mechanism 4 reciprocates the inkjet heads 5 in the Y direction. Specifically, the scanning mechanism 4 is provided with a pair of guide rails 21, 22, a carriage 23, and a drive mechanism 24, wherein the pair of guide rails 21, 22 extend in the Y direction, the carriage 23 is movably supported by the pair of guide rails 21, 22, and the drive mechanism 24 moves the carriage 23 in the Y direction.

The drive mechanism 24 is disposed between the guide rails 21, 22 in the X direction. The drive mechanism 24 is provided with a pair of pulleys 25, 26, an endless belt 27, and a drive motor 28, wherein the pair of pulleys 25, 26 are disposed in the Y direction with a distance, the endless belt 27 is wound between the pair of pulleys 25, 26, and the drive motor 28 rotationally drives the pulley 25 as one of the pulleys 25, 26.

The carriage 23 is connected to the endless belt 27. On the carriage 23, there is mounted the plurality of inkjet heads 5 in the state of being arranged in the Y direction.

The inkjet heads 5 are configured so as to be able to eject ink of respective colors different from each other such as yellow, magenta, cyan, and black.

The ink tanks 30 are disposed separately from the inkjet heads 5 (the carriage 23) in the housing 8. The ink tanks 30 are arranged side by side in the X direction in the housing 8. In the ink tanks 30, there are housed the inks of the respective colors different from each other so as to correspond to the inkjet heads 5 described above.

The ink circulation unit 6 is provided with a circulation flow channel 31, pressuring pumps 17, and suction pumps 18.

The circulation flow channel 31 has ink supply tubes 31a for supplying the respective inkjet heads 5 with the ink, and ink outlet tubes 31b for discharging the ink from the respective inkjet heads 5. The ink supply tubes 31a and the ink outlet tubes 31b are each formed of a flexible hose or the like so as to be able to follow the movement of the carriage 23.

### [Inkjet Head]

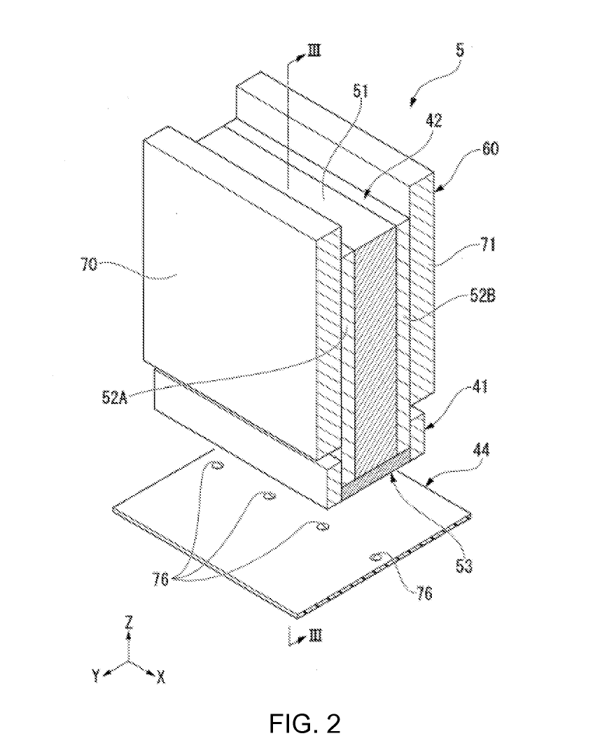

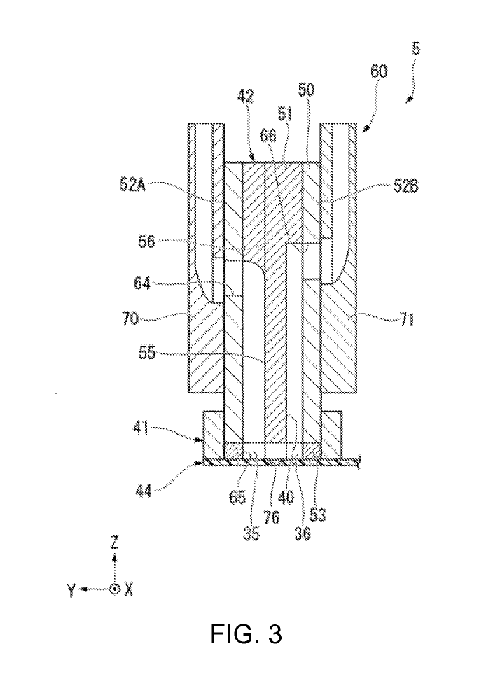

FIG. 2 is a schematic perspective view showing a general configuration of the inkjet head 5. Further, FIG. 3 is a cross-sectional view along the III-III line shown in FIG. 2. It should be noted that the inkjet heads 5 have the same configuration except the color of the ink supplied. Therefore, in the following explanation, the description will be presented using one of the inkjet heads 5 as an example, and the description of the others of the inkjet heads 5 will be omitted.

The inkjet head 5 is of a so-called edge-shoot type for ejecting the ink from an end part (a −Z-direction end part) in the extending direction of an ejection channel 55 described later. Further, as the inkjet head 5, there is adopted an inkjet head of the circulation type (vertical circulation type) for circulating the ink with the ink tank 30.

The inkjet head 5 is provided with a base member 41, a chip module 60, and a nozzle plate 44. The chip module 60 has a head chip 42, an inlet flow channel member 70, and an outlet flow channel member 71.

The head chip 42 of the chip module 60 has an actuator plate 51, an inlet cover plate 52A, an outlet cover plate 52B, and a return plate 53.

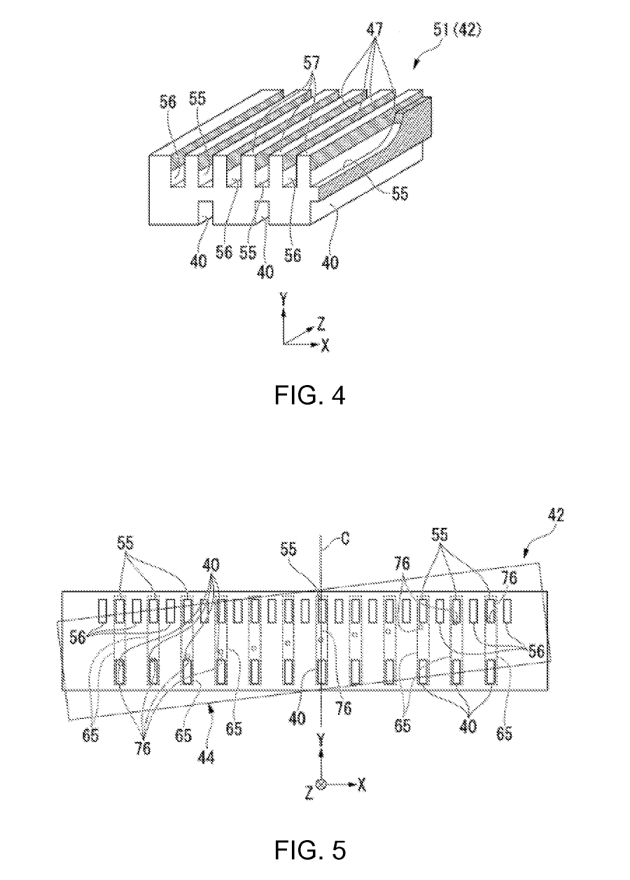

FIG. 4 is a partial cross-sectional perspective view of a part (the actuator plate 51) of the head chip 42.

A +Y-direction end surface in the actuator plate 51 is provided with a plurality of ejection channels 55 and a plurality of non-ejection channels 56 formed alternately in the X direction at intervals. The ejection channels 55 and the non-ejection channels 56 are each formed linearly along the Z direction. The ejection channel 55 and the non-ejection channel 56 adjacent to each other are partitioned in the X direction by a drive wall 57. The actuator plate 51 is a so-called monopole substrate, the polarization direction of which is set to a single direction along the thickness direction. Electrodes 47 for driving are disposed respectively on the inner surfaces (the drive walls 57) of the ejection channels 55 and the non-ejection channels 56 using, for example, vapor deposition.

In the ejection channel 55 of the actuator plate 51, when a voltage having a rectangular shape is applied between the electrodes 47 located across the drive wall 57, the drive walls 57 opposed to each other deform to thereby increase or decrease the capacity. On this occasion, the ejection channel 55 performs a filling operation and an extruding operation of a predetermined amount of ink. In the present embodiment, the ejection channel 55 of the actuator plate 51 forms the fluid-pressure variation chamber. It should be noted that the operation of each of the ejection channels 55 is individually controlled in response to a drive signal from the control section.

In contrast, a −Y-direction end surface in the actuator plate 51 is provided with circulation channels 40. The circulation channels 40 are each recessed from the −Y-direction end surface in the actuator plate 51 toward the +Y direction, and each extend from the −Z-direction end surface of the actuator plate 51 to a midway part in the +Z direction. The circulation channels 40 are each formed at a position adjacent in the −Y direction to each of the ejection channels 55 on the actuator plate 51.

Further, as shown in FIG. 3, the inlet cover plate 52A is bonded to the +Y-direction end surface of the actuator plate 51. The inlet cover plate 52A closes the ejection channels 55 and the non-ejection channels 56 described above from the +Y direction. In the inlet cover plate 52A, at positions overlapping the +Z-direction end parts of the respective ejection channels 55 described above viewed from the Y direction, there are formed ink introduction ports 64 for introducing the ink into the ejection channels 55 from the inlet flow channel member 70, respectively. The inlet flow channel member 70 is supplied with the ink from the ink tank 30 through the ink supply tube 31a of the circulation flow channel 31 described above.

The outlet cover plate 52B is bonded to the −Y-direction end surface of the actuator plate 51. The outlet cover plate 52B closes the circulation channel 40 from the −Y direction. In the outlet cover plate 52B, at positions overlapping the +Z-direction end parts of the respective circulation channels 40 viewed from the Y direction, there are formed ink discharge ports 66 for flowing out the ink toward the outlet flow channel member 71 from the circulation channel 40, respectively. The ink having flowed out to the outlet flow channel member 71 is returned to the ink tank 30 through the ink outlet tube 31b of the circulation flow channel 31 described above.

The return plate 53 is bonded collectively to the −Z-direction end surfaces of the actuator plate 51, the inlet cover plate 52A, and the outlet cover plate 52B. In the return plate 53, at the positions overlapping the ejection channels 55 and the circulation channels 40 adjacent thereto viewed from the Z direction, there are formed return channels 65 each shaped like an elongated hole, respectively. The return channels 65 are each formed so as to penetrate the return plate 53 in the Z direction. The return channels 65 each communicate the ejection channel 55 and the circulation channel 40 adjacent to the ejection channel 55 with each other.

It should be noted that each of the return channels 65 extends in parallel to the nozzle plate 44 along the Y direction, and substantially orthogonally crosses the outflow direction (the Z direction) of the ink from the ink outflow part of the ejection channel 55, and substantially orthogonally crosses the extending direction of the circulation channel 40. The return channels 65 extend in parallel to the nozzle plate 44. Further, an upstream side connection area 35 to be connected to the ejection channel 55 of each of the return channels 65 is provided to the +Y-direction end part of the return channel 65, and a downstream side connection area 36 to be connected to the circulation channel 40 of each of the return channels 65 is provided to the −Y-direction end part of the return channel 65. It should be noted that in the specification, the upstream side connection area 35 denotes an area where the extended part in the longitudinal direction of the ejection channel 55 and the return channel 65 overlap each other, and the downstream side connection area 36 denotes an area where the extended part in the longitudinal direction of the circulation channel 40 and the return channel 65 overlap each other.

Further, the nozzle plate 44 is formed from a resin material such as polyimide resin so as to have a plate-like shape, and is collectively bonded to the −Z end surfaces of the return plate 53 and the base member 41. The nozzle plate 44 is provided with jet holes (nozzles) 76 for jetting the ink having flowed out from the respective ejection channels 55 of the actuator plate 51 to the outside. The return channels 76 are each formed so as to penetrate the nozzle plate 44 in the Z direction.

In the inkjet head 5 according to the present embodiment, the return channels 65 are formed so that the cross-sectional area of the return channel 65 is constant throughout the range in the extending direction, and the jet holes 76 provided to the nozzle plate 44 are each disposed in an area except the upstream side connection area 35 and the downstream side connection area 36 on the return channel 65, preferably a central area (a central area between the upstream side connection area 35 and the downstream side connection area 36) in the extending direction on the return channel 65. The jet holes 76 are each disposed more preferably at the central position in the extending direction on the return channel 65.

Incidentally, to the electrodes 47 on the drive walls 57 of the ejection channels 55 of the actuator plate 51, the rectangular voltage pulse with the pulse width designated by the control section is applied, and thus, the capacity of each of the ejection channels 55 varies to be larger or smaller. On this occasion, for example, the ejection channel 55 expands due to the rising edge of the voltage pulse, and thus, a first pressure wave occurs in the ink moving toward the return channel 65. Further, the expansion of the ejection channel 55 stops due to the falling edge of the subsequent voltage pulse, and thus, a second pressure wave occurs in the ink moving toward the return channel 65. In the jet hole 76, the jet of the ink is performed due to the composite wave of the first pressure wave and the second pressure wave.

In order to stabilize landing of the ink to the recording target medium P, it is preferable to perform the jet of the ink at the resonance point of the first pressure wave and the second pressure wave. In other words, it is preferable to perform the jet of the ink with the pulse width for maximizing the ejection speed of the ink in the jet hole 76 in the same voltage. Therefore, it is arranged that the voltage pulse with the pulse width for maximizing the composite wave of the first pressure wave and the second pressure wave described above is applied to the electrodes of each of the ejection channels 55. In other words, the ejection channels 55 are each driven by the voltage pulse with the peak pulse width (the pulse width for maximizing the ejection speed).

Further, as a result of the experiment conducted by the applicant, it has been found that there exists the following relationship between the position of the jet hole 76 on the return channel 65 and the peak pulse width.

Specifically, in the case in which the cross-sectional area of the return channel 65 is constant throughout the range in the extending direction, the peak pulse width is maximized in the case in which the jet hole 76 is located at the central position (an intermediate position between the upstream side connection area 35 and the downstream side connection area 36 in the return channel 65) in the extending direction of the return channel 65, and gradually decreases as the displacement from the central position increases if the position of the jet hole 76 is displaced from the central position in either of the forward direction and the backward direction.

FIG. 5 is a diagram schematically showing an experiment described above for examining the relationship between the position of the jet hole 76 and the peak pulse width.

In the experiment, there are used the head chip 42 and the nozzle plate 44, therein the head chip 42 is provided with the ejection channels 55 and the non-ejection channels 56 formed alternately side by side along the X direction, and the circulation channels 40 formed at the positions adjacent to the ejection channels 55 in the Y direction, and the jet holes 76 corresponding to the respective ejection channels 55 of the head chip 42 are formed in the central area in the Y direction of the nozzle plate 44. Although not shown in FIG. 5, to the −Z-direction end surface of the head chip 42, there is bonded the return plate 53 for connecting the ejection channels 55 to the circulation channels 40 adjacent to the ejection channels 55, respectively. In FIG. 5, there are shown the return channels 65 of the return plate 53 alone. Therefore, the ejection channels 55 and the circulation channels 40 adjacent to the ejection channels 55 are connected to each other by the return channels 65 of the return plate 53, respectively.

In the present experiment, there is adopted the setting in which the nozzle plate 44 is tilted in the X-Y plane with respect to the head chip 42, and accordingly, the positions of the jet holes 76 on the respective return channels 65 are gradually shifted from the −X side toward the +X side. Further, in the state of shifting the nozzle plate 44 in such a manner, the peak pulse width in each of the jet holes 76 is examined.

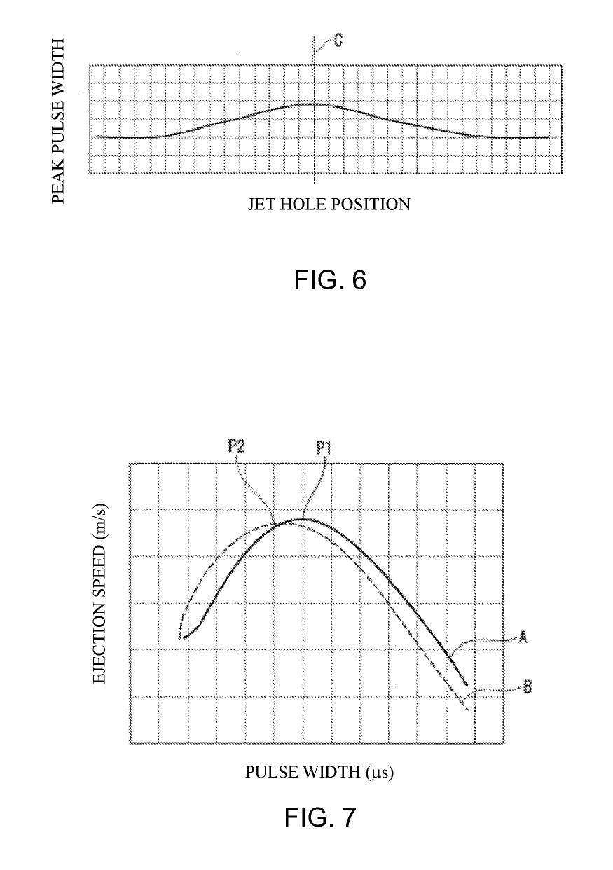

FIG. 6 is a graph showing a result of the experiment described above. In the graph shown in FIG. 6, the horizontal axis represents the position of the jet hole 76, and the vertical axis represents the peak pulse width at each of the positions.

As a result of the experiment described above, as shown in FIG. 6, it has been found that the peak pulse width is maximized in the case in which the jet hole 76 is located at substantially the central position C in the extending direction of the return channel 65, and the peak pulse width gradually decreases in accordance with the displacement amount in the case in which the position of the jet hole 76 is displaced from the central position C of the return channel 65 toward either of the −Y side (the circulation channel 40 side) and the +Y side (the ejection channel 55 side).

FIG. 7 is a graph showing the relationship between the pulse width of the voltage to be applied to the electrodes 47 of the drive walls 57 of the ejection channels 55 and the ejection speed. In FIG. 7, the line A represents the relationship between the pulse width of the voltage and the ejection speed in the case of disposing the jet hole 76 at the central position C of the return channel 65, and the line B represents the relationship between the pulse width of the voltage and the ejection speed in the case of disposing the jet hole 76 at the position with a long distance from the central position C of the return channel 65.

The point P1 in FIG. 7 represents the peak pulse width in the case of disposing the jet hole 76 at the central position C of the return channel 65 and the ejection speed in that case, and the point P2 represents the peak pulse width in the case of disposing the jet hole 76 distant from the central position C of the return channel 65 and the ejection speed in that case. In the data acquisition of the graph shown in FIG. 6, the pulse width of the voltage pulse and the corresponding ejection speed are examined at each of the positions of the jet hole 76, and then the pulse width maximizing the ejection speed is obtained as the peak pulse width as shown in FIG. 7.

In the case of the inkjet head 5 according to the present embodiment, since the jet hole 76 is disposed in the central area in the extending direction of the return channel 65, by driving the ejection channel 55 with the peak pulse width corresponding to the position at which the jet hole 76 is disposed, it is possible to make the ink stably land on the recording target medium P from the jet hole 76.

It should be noted that since an error is included in the position of the jet hole 76 and so on when actually manufacturing the inkjet head 5, some degree of error occurs with respect to the design position of the jet hole 76. However, in the inkjet head 5 according to the present embodiment, since the jet hole 76 is disposed in the central area in the extending direction of the return channel 65, even if the position of the jet hole 76 is slightly displaced from the design position due to the manufacturing error or the like in some cases, it is possible to narrow the width between the upper limit error and the lower limit error of the ejection speed due to the displacement. In other words, in the inkjet head 5 according to the present embodiment, since the position in the vicinity of the peak of the peak pulse width of the graph shown in FIG. 6 is defined as the jet hole position, it is possible to hold down the width between the upper limit error and the lower limit error of the ejection speed due to the displacement to substantially a half compared to the case of setting the position in the midway part of the rising slope part or the falling slope part of the peak of the peak pulse width of the graph shown in FIG. 6 as the jet hole position. Therefore, in this inkjet head, it is possible to reduce the variation in ejection speed between the products.

As described above, in the inkjet head 5 according to the present embodiment, each of the jet holes 76 of the nozzle plate 44 is disposed in the area except the upstream side connection area 35 connected to the ejection channel 55 (the pressure variation chamber) and the downstream side connection area 36 connected to the circulation channel 40 out of the return channel 65. In the area except the upstream side connection area 35 and the downstream side connection area 36 on the return channel 65, since the flow of the ink flowing back is smooth, the foreign matters or the bubbles are hard to be accumulated around the jet hole 76 disposed in this part. Therefore, in the inkjet head 5 according to the present embodiment, it is possible to reduce the accumulation of the foreign matters or the bubbles in the vicinity of the jet hole 76, and it is possible to stably jet the ink from the jet hole 76.

In the case of adopting the configuration in which the return channel 65 is substantially perpendicular to the outflow direction of the ink from the ejection channel 55 and the extending direction of the circulation channel 40, and is parallel to the nozzle plate 44 as in the present embodiment, the foreign matters or the bubbles become easy to be accumulated in the upstream side connection area 35 and the downstream side connection area 36 on the return channel 65. However, in the inkjet head 5 according to the present embodiment, since the jet hole 76 is disposed in the area except the upstream side connection area 35 and the downstream side connection area 36 on the return channel 65, it is possible to particularly effectively prevent the foreign matters or the bubbles accumulated from hindering the jet of the ink.

Further, in the inkjet head 5 according to the present embodiment, the jet hole 76 is disposed in the central area between the upstream side connection area 35 and the downstream side connection area 36 out of the return channel 65. Therefore, since it becomes that the jet hole 76 is disposed in the area where the flow of the ink toward the circulation channel 40 becomes the smoothest of the return channel 65, it is possible to more effectively prevent the foreign matters or the bubbles from being accumulated around the jet hole 76.

Further, in the inkjet head 5 according to the present embodiment, since the jet hole 76 of the nozzle plate 44 is disposed in the central area between the upstream side connection area 35 and the downstream side connection area 36 on the return channel 65, more desirably at the central position therebetween, even if the position of the jet hole 76 is slightly displaced from the design position due to the manufacturing error or the like in some cases as described above, it is possible to narrow the width between the upper limit error and the lower limit error of the ejection speed due to the displacement. Therefore, in the case of adopting the inkjet head 5 according to the present embodiment, it is possible to reduce the variation in ejection speed between the products.

Incidentally, in the embodiment described above, under the condition that the cross-sectional area of the return channel 65 is constant in the entire area in the extending direction, the jet hole 76 of the nozzle plate 44 is disposed in the central area between the upstream side connection area 35 and the downstream side connection area 36 on the return channel 65.

However, by arranging that the jet hole 76 is disposed in an area where the flow channel pressure loss from the upstream side connection area 35 to the jet hole 76 and the flow channel pressure loss from the downstream side connection area 36 to the jet hole 76 are substantially equal to each other out of the return channel 65, it is possible to similarly reduce the variation in the ejection speed due to the slight displacement of the jet hole 76 caused by the manufacturing error or the like even if the cross-sectional area of the return channel 65 is not necessarily constant.

Here, the flow channel pressure loss ΔP can be expressed as the following formula (1).

ΔP=λ·l·ρ·u²/2d (1)

Where, λ: tube friction coefficient, l: pipe length, ρ: fluid density, u: average flow rate, d: pipe diameter

Here, defining the flow channel pressure loss on the upstream side of the return channel 65 as ΔP₁, the flow channel pressure loss on the downstream side of the return channel 65 as ΔP₂, it is sufficient for the jet hole 76 of the nozzle plate 44 to be disposed at the position on the return channel 65 substantially fulfilling ΔP₁=ΔP₂.

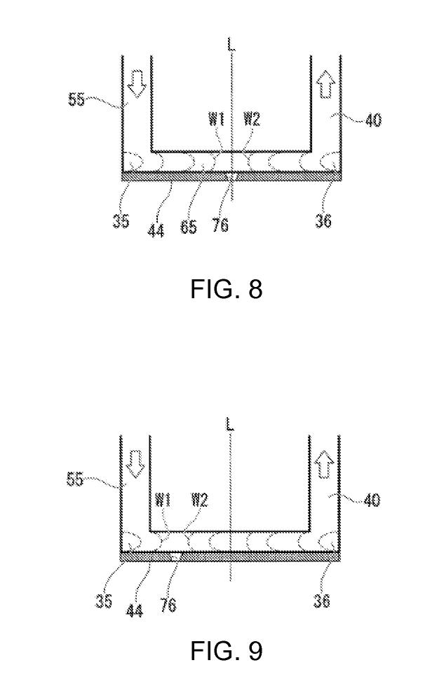

FIG. 8 is a diagram showing the condition of the reflection of the first pressure wave in the case in which the jet hole 76 is disposed at the position L fulfilling ΔP₁=ΔP₂ in the return channel 65, and FIG. 9 is a diagram showing the condition of the reflection of the first pressure wave in the case in which the jet hole 76 is disposed at a position significantly displaced from the position L fulfilling ΔP₁=ΔP₂ in the return channel 65.

In the ejection channel 55, the first pressure wave occurs due to the expansion of the ejection channel 55 caused by the rising edge of the voltage pulse, and the second pressure wave occurs due to the stoppage of the expansion of the ejection channel 55 caused by the subsequent falling edge of the voltage pulse as described above. Further, in the jet hole 76, the jet from the jet hole 76 is performed due to the resonance of the first pressure wave and the second pressure wave.

In the case in which the jet hole 76 is disposed at the position L fulfilling ΔP₁=ΔP₂ as shown in FIG. 8, the reflected wave w1 of the first pressure wave proceeding in the downstream direction and the reflected wave w2 of the first pressure wave trying to proceed in the upstream direction reach the jet hole 76 at the same speed, and these reflected waves resonate with the second pressure wave to jet the ink from the jet hole 76.

In contrast, in the case in which the jet hole 76 is disposed at the position displaced toward, for example, the upstream side from the position L fulfilling ΔP₁=ΔP₂ as shown in FIG. 9, the reflected wave w1 of the first pressure wave reaching the jet hole 76 earlier resonates with the second pressure wave to jet the ink from the jet hole 76.

Therefore, the peak pulse width becomes the largest at the position fulfilling ΔP₁=ΔP₂, and gradually decreases in accordance with the displacement amount if the position is displaced from the position fulfilling ΔP₁=ΔP₂.

Therefore, in this case, by disposing the jet hole 76 in the area where the flow channel pressure loss from the upstream side connection area 35 and the flow channel pressure loss from the downstream side connection area 36 are substantially equal to each other on the return channel, it is possible to reduce the variation in ejection speed due to the slight displacement of the jet hole 76 caused by the manufacturing error or the like.

It should be noted that the invention is not limited to the embodiment described above, but can be provided with a variety of design changes within the scope or the spirit of the invention.

What is claimed is:

1. A liquid jet head comprising:
a pressure variation chamber adapted to apply a pressure variation to a liquid filled in the pressure variation chamber;
a return channel communicated with an outflow part of the pressure variation chamber on an upstream side of the return channel, and extending in a direction crossing an outflow direction of the liquid from the outflow part;
a circulation channel communicated with a downstream side of the return channel, and extending in a direction crossing the return channel, so as to return the liquid to an upstream side of the pressure variation chamber; and
a jet hole adapted to jet the liquid outside, the liquid having flowed out from the pressure variation chamber,
wherein the jet hole is disposed in an area of the return channel except an upstream side connection area connected to the outflow part of the pressure variation chamber and a downstream side connection area connected to the circulation channel.

2. The liquid jet head according to claim 1, wherein
the jet hole is disposed in a central area of the return channel between the upstream side connection area and the downstream side connection area.

3. The liquid jet head according to claim 1, wherein
the jet hole is disposed in an area of the return channel where a flow channel pressure loss from the upstream side connection area to the jet hole and a flow channel pressure loss from the downstream side connection area to the jet hole are substantially equal to each other.

4. The liquid jet head according to claim 1, further comprising:
a jet hole plate having the jet hole,
wherein the return channel extends in a direction substantially perpendicular to an inflow direction of the liquid from the pressure variation chamber to the return channel, and an outflow direction from the return channel to the circulation channel, and extends in parallel to the jet hole plate.

5. The liquid jet head according to claim 2, further comprising:
a jet hole plate having the jet hole,
wherein the return channel extends in a direction substantially perpendicular to an inflow direction of the liquid from the pressure variation chamber to the return channel, and an outflow direction from the return channel to the circulation channel, and extends in parallel to the jet hole plate.

6. The liquid jet head according to claim 3, further comprising:
a jet hole plate having the jet hole,
wherein the return channel extends in a direction substantially perpendicular to an inflow direction of the liquid from the pressure variation chamber to the return channel, and an outflow direction from the return channel to the circulation channel, and extends in parallel to the jet hole plate.

7. A liquid jet recording device comprising:
the liquid jet head according to claim 1.
